(19) United States
(12) Patent Application Publication
(10) Pub. No.: US 2012/0210035 A1
(43) Pub. Date: Aug. 16, 2012

(54) DEVICE FOR A MULTI-BOOT SYSTEM WITH NETWORK SWITCHES

(76) Inventors: Way-Dir HIR, Tainan City (TW); Sung-Fei WANG, Tainan City (TW)

(21) Appl. No.: 13/367,573

(22) Filed: Feb. 7, 2012

(30) Foreign Application Priority Data
Feb. 14, 2011 (TW) 100202691

(51) Int. Cl. G06F 13/14

(52) U.S. Cl. 710/305

(57) ABSTRACT

A device for a multi-boot system with network switches has a box, a selection module and a bridge connecting card. The box has an operation panel mounted with multiple switches. The selection module is mounted in the box and has a hard disk selector and a network selector. The hard disk selector has a power input port, multiple power output ports connected to the power input port via part of the switches. The network selector has a network input port and a network output port connected to the network input port via the other switches and is connected to a network cable. The bridge connecting card is mounted outside of the box. The multiple switches can form multiple combinations. Each combination corresponds to one operating system for booting and the communicating status with Internet.

### BACKGROUND OF THE INVENTION

1. Field of the Invention

The present invention relates to a device for a multi-boot system, and more particularity to a device for a multi-boot system with network switches.

2. Description of Related Art

With reference to FIG. 9 and FIG. 10, a host 60 of a personal computer (PC) is illustrated. The host 60 mainly comprises a case 61, a power supply 62, a motherboard 63 and at least one hard disk 64.

The power supply 62, the motherboard 63 and the hard disks 64 are mounted in the case 61. The power supply 62 is electrically connected to the motherboard 63 and the hard disks 64 to provide operating voltages. The motherboard 63 is electrically connected to the hard disks 64 and has a network port 630. The network port 630 is applied to connect to a network cable 65 to communicate with the Internet.

An operating system (OS) is a set of programs that manage computer hardware resources and provide common services for application software. With the advances of computer technologies, different operating systems are developed, such as Windows XP, Windows 7, Macintosh, etc. The operating system is installed in a master hard disk. The operating system installed in the master hard disk can be booted.

However, only one operating system may not be sufficient for all users. Some users may install multiple operating systems in a same master hard disk if necessary. Although the master hard disk is equipped with multiple operating systems, only one of them is selected to boot the host at a same time.

A conventional method to select one of the operating systems is to organize BIOS or BootCamp. However, to organize such BIOS or BootCamp is too complex to operate for ordinary users. Another method to solve the problems is by using multiple removable hard disks. The removable hard disk is mounted in an external hard disk case for electrically connecting to the motherboard. Therefore, the user can boot a certain operating system that is selected and mounted in the external hard disk case.

In addition, when the computer with multiple hard disks communicates with the Internet, a risk of infections by viruses may take place. The user can replace the original (primary) master hard disk in the external hard disk with another (secondary) master hard disk for connecting to the Internet. Hence, the original master hard disk detached from the external hard disk case avoids being infected by the viruses. However, if the user forgets to remove the master hard disk that should be insulated from the Internet, such master hard disk is exposed to risk.

### SUMMARY OF THE INVENTION

According to the disadvantages of the usage of the removable hard disk modules and the risk of infections, an objective of the present invention is to provide a device for a multi-boot system with network switches to solve the problems.

To achieve the foregoing objective, the device for a multi-boot system with network switches comprises a box, a selection module and a bridge connecting card.

The box has an operation panel mounted with multiple switches.

The selection module comprises a substrate mounted in the box, a hard disk selector mounted on the substrate and electrically connected to the switches and a network selector mounted on the substrate and electrically connected to the switches. The hard disk selector has a power input port, multiple power output ports and multiple plugs respectively connected to the power output ports. The power input port is adapted to connect to a power supply. The multiple power output ports are connected to the power input port via part of the switches and are respectively adapted to connect to hard disks. The network selector has a network input port and a network output port. The network output port is connected to the network input port via the other switches and is adapted to connect to a network connector of a host via a network cable.

The bridge connecting card is mounted outside of the box and has a network connector and a hole. The network connector is electrically connected to the network input port of the network selector and is adapted to communicate with Internet. The hole allows the network cable to pass through the bridge connecting card to connect to the network output port.

The power input port is applied to connect to a power supply to receive an operating voltage. The power output ports are respectively connected to multiple hard disks to provide operating voltages. The multiple switches can form multiple combinations. One combination allows booting the operating system of one corresponding hard disk. The forgoing method to boot an operating system is to recognize firmwares, such as BIOS and BootCamp. The present method to boot an operating system is to operate hardwares, such as the switches. Operating the switches is much easier than recognizing firmwares for users.

In addition, the hard disks cannot communicate with the Internet until the network input port is connected to the network output port of the network selector. Hence, a user has to pay more attention to operate the switches. The incorrect operation that accidentally communicates a certain hard disk with Internet will efficiently decrease.

The present invention has three technical features:

1. In order to enable this device booted by multi-boot system, a single power cord will be applied to connect with each cord mounted on each single hard disk drive. Moreover, a switch will be designed to ensure that the power will only supply to the selected hard disk drive.

2. A shielded structure will be designed to prevent the non-selected hard disks being turned-on or turned-off.

3. For the security reason, a network system with multi-switch will be setup to control the signal only connecting with the selected hard disk drive.

In addition, for security reasons, the idea indicated in “1.” can also be applied on a laptop computer, desktop computer, or any network connecting device field with double hard disks. Thus, only the selected hard disk on the laptop can be operated by powered-on.

### BRIEF DESCRIPTION OF THE DRAWINGS

FIG. 1 is an exploded perspective view of a first embodiment;

FIG. 2 is a perspective view of the first embodiment;

FIG. 3 is an operating view of the box inserted into the host;

FIG. 4 is a perspective view of a host equipped with the device in accordance with the present invention;

FIG. 5 is a circuit diagram of the selection module of the first embodiment;

FIG. 6 is a perspective view of a second embodiment;

FIG. 7 is a circuit diagram of the selection module of the second embodiment;

FIG. 8 is a perspective view of the second embodiment with a shield;

FIG. 9 is a perspective view of a conventional host; and

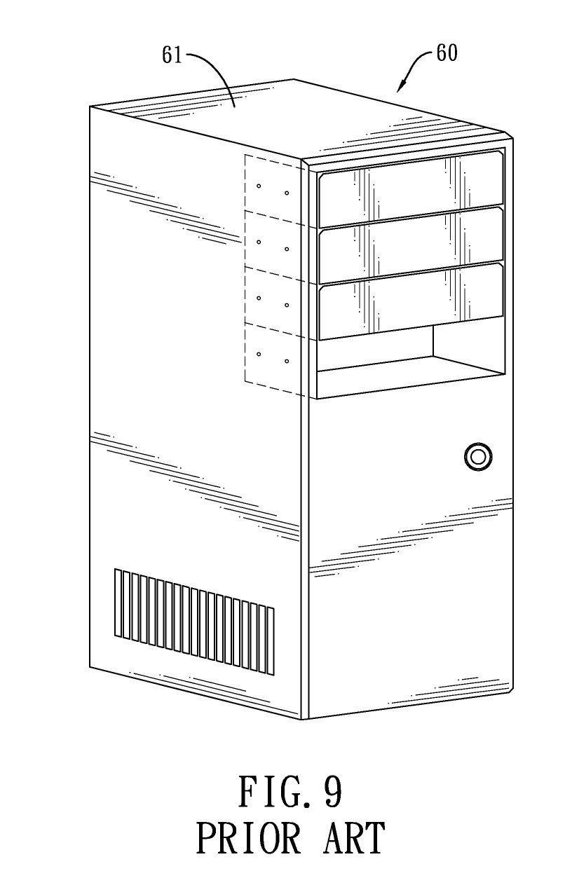

FIG. 10 is another perspective view showing the inner space of the conventional host.

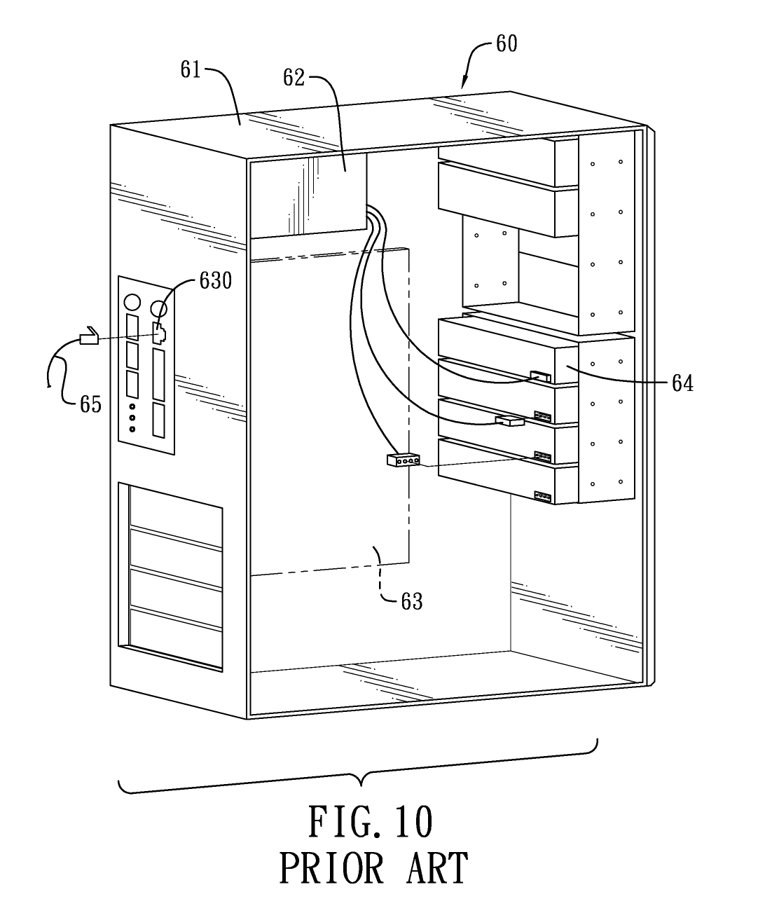

### DETAILED DESCRIPTION OF THE PREFERRED EMBODIMENT

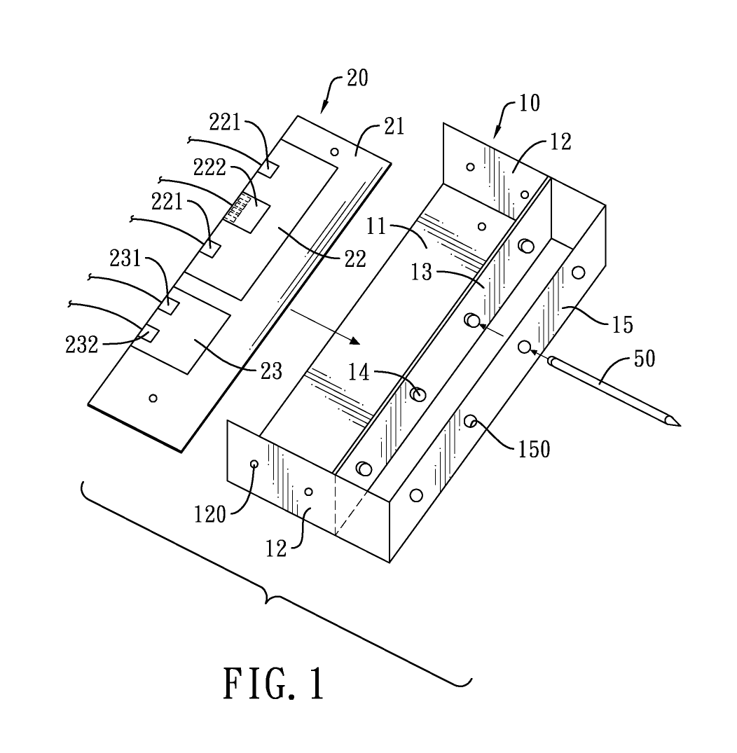

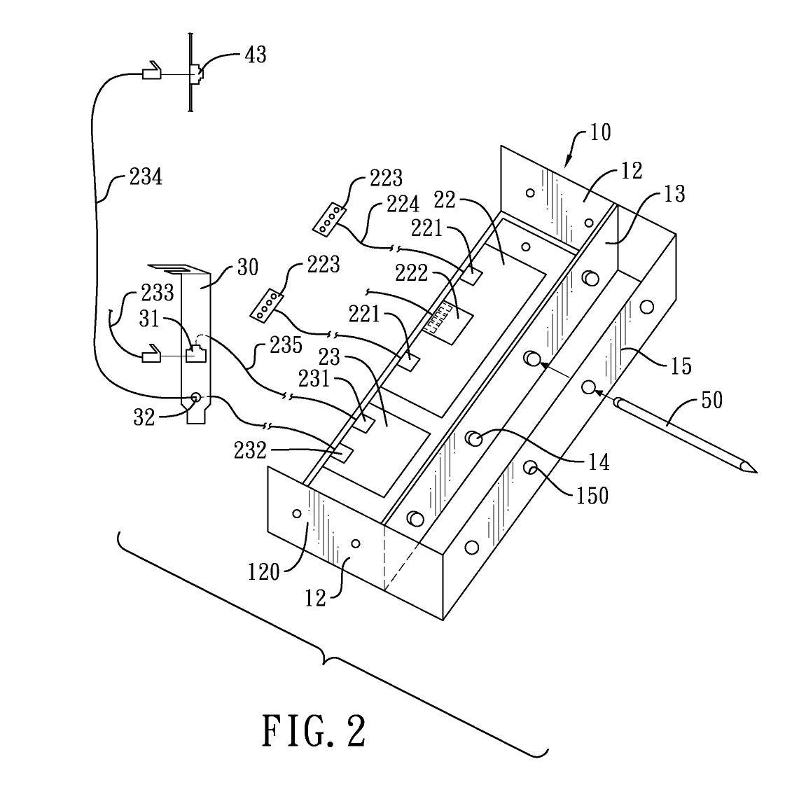

With reference to FIG. 1 and FIG. 2, a first embodiment in accordance with the present invention is disclosed. The first embodiment comprises a box 10, a selection module 20 and a bridge connecting card 30.

The box 10 has a plate 11, two side slabs 12 and an operation panel 13. The plate 11 has two opposite edges and a front side. The two slabs 12 are respectively mounted on the two edges. The operation panel 13 is mounted on the front side. On the operation panel 13 are multiple switches 14. The switches 14 can be jump switches, dip switches, toggle switches, push-button switches, etc.

The box 10 can further comprise a shield 15 mounted in front of the operation panel 13 and separated from the operation panel 13. The shield 15 has multiple holes 150 respectively corresponding to the switches 14.

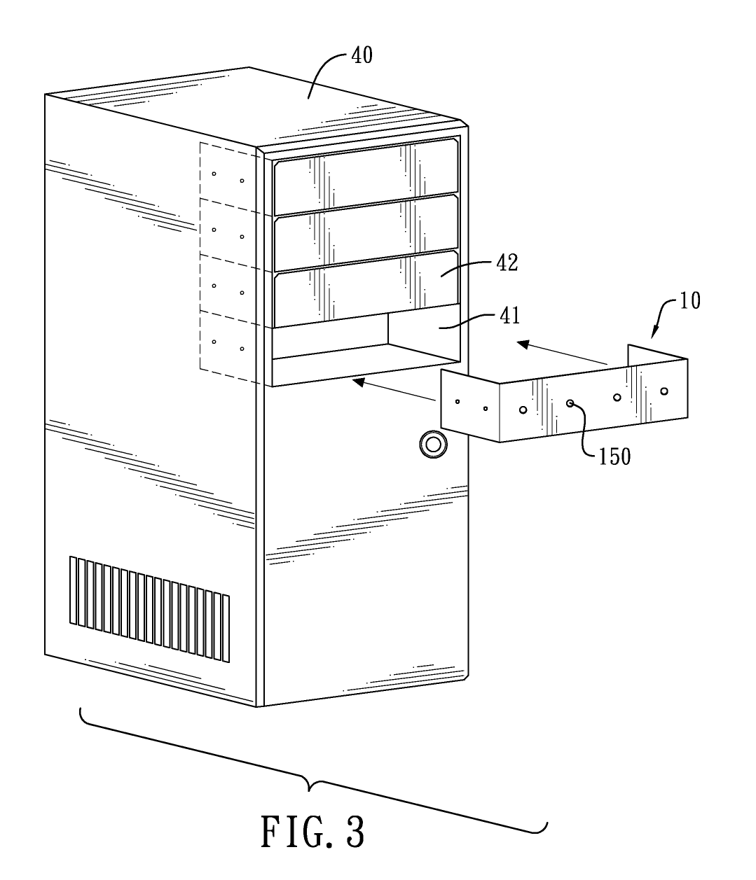

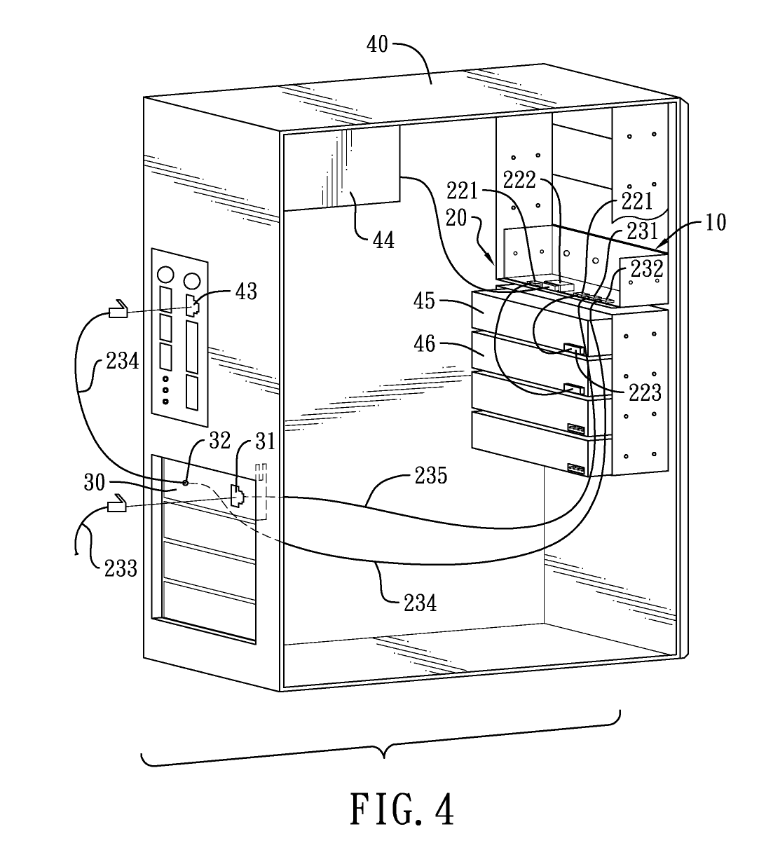

With further reference to FIG. 3 and FIG. 4, a detachable cover 42 can be removed from a host 40 to reveal a socket 41. The box 10 is to be inserted into the socket 41 of the host 40. The slabs 12 of the box 10 have multiple lock holes 120 for firmly securing the box 10 to the socket 41.

The selection module 20 has a substrate 21, a hard disk selector 22 and a network selector 23. The substrate 21 is mounted on the plate 11 and behind the operation panel 13. The hard disk selector 22 and the network selector 23 are mounted on the substrate 21. The hard disk selector 22 is electrically connected to part of the switches 14 and has multiple power output ports 221, a power input port 222 and multiple plugs 223. The plugs 223 are respectively connected to the power output ports 221 via cables 224. The multiple power output ports 221 are connected to the power input port 222 via the part of the switches 14. The network selector 23 is electrically connected to the other switches 14 and has a network input port 231 and a network output port 232. The network input port 231 is applied to connect to a network cable 233 to communicate with the Internet. The network output port 232 is connected to the network input port 231 via the other switches 14 and is applied to connect to a network connector 43 of the host 40.

With reference to FIG. 4, the bridge connecting card 30 is mounted outside of the box 10. For example, the bridge connecting card 30 is applied to be mounted on a back of the host 40. The bridge connecting card 30 has a network connector 31 and a hole 32. The network connector 31 is applied to receive the network cable 233 and is electrically connected to the network input port 231 of the network selector 23 via a cable 235. The network output port 232 of the network selector 23 is electrically connected to the network connector 43 of the host 40 via a network cable 234 passing through the hole 32. The host 40 comprises a motherboard, a power supply 44, a first hard disk 45 and a second hard disk 46. The hard disks 45, 46 are equipped with different operating systems. The power supply 44 is electrically connected to the motherboard and the power input port 222 of the hard disk selector 22 to provide operating voltages. The motherboard is electrically connected to the network connector 43 and the hard disks 45, 46.

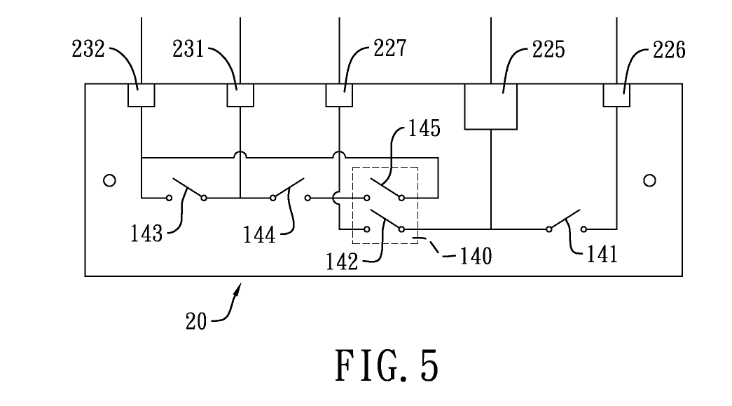

With reference to FIG. 5, a circuit diagram of the selection module and the switches of the operation panel 13 is disclosed. In this embodiment, the switches of the operation panel comprise a first hard disk switch 141, a second hard disk switch 142, a first network switch 143, a second network switch 144 and a third network switch 145. The second hard disk switch 142 and the third network switch 145 may form a synchronous switch pair 140. The synchronous switch pair 140 means that both the second hard disk switch 142 and the third network switch 145 are always simultaneously turned ON or OFF. The hard disk selector 22 comprises a power input port 225, a first power output port 226 and a second power output port 227. The first hard disk switch 141 is electrically connected between the power input port 225 and the first power output port 226. The second hard disk switch 142 is electrically connected between the power input port 225 and the second power output port 227. The first network switch 143 is electrically connected between the network input port 231 and the network output port 232 of the network selector 23. The second network switch 144 and the third network switch 145 are connected in series and are electrically connected between the network input port 231 and the network output port 232 of the network selector 23.

According to the first embodiment in accordance with the present invention, there are multiple switch combinations that users can make use of. The hard disks 45, 46 are able to communicate with the internet in some cases. For example, when the first hard disk switch 141 is ON and the second hard disk switch 142 is OFF, the first hard disk 45 can receive the operating voltage through the power input port 225 and the first power output port 226 and then the operating system installed in the first hard disk 45 can be booted. When the second hard disk switch 142 is ON and the first hard disk switch 141 is OFF, the second hard disk 46 can receive the operating voltage through the power input port 225 and the second power output port 227 and then the operating system installed in the second hard disk 46 can be booted. Only if the first network switch 143 is ON or the second network switch 144 and the third network switch 145 are both ON can the hard disks 45, 46 communicate with the Internet.

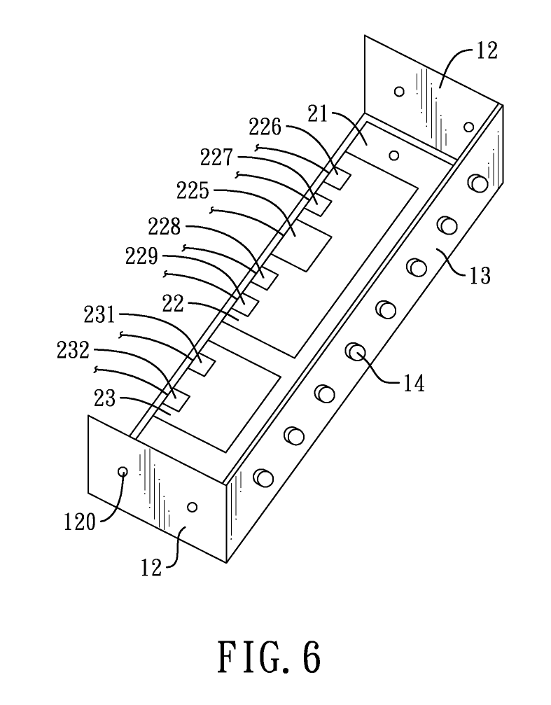

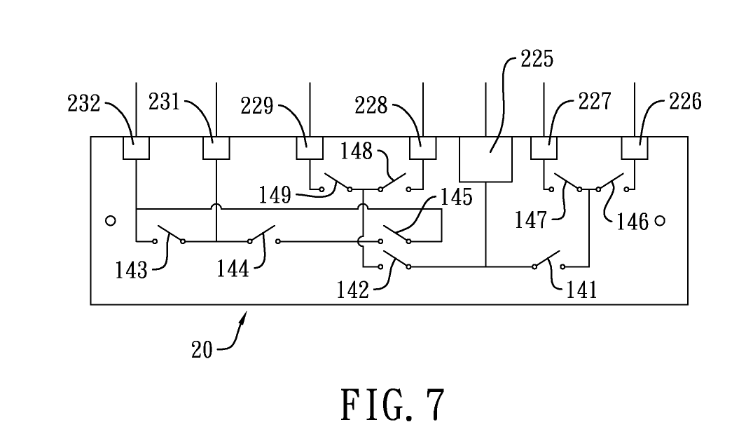

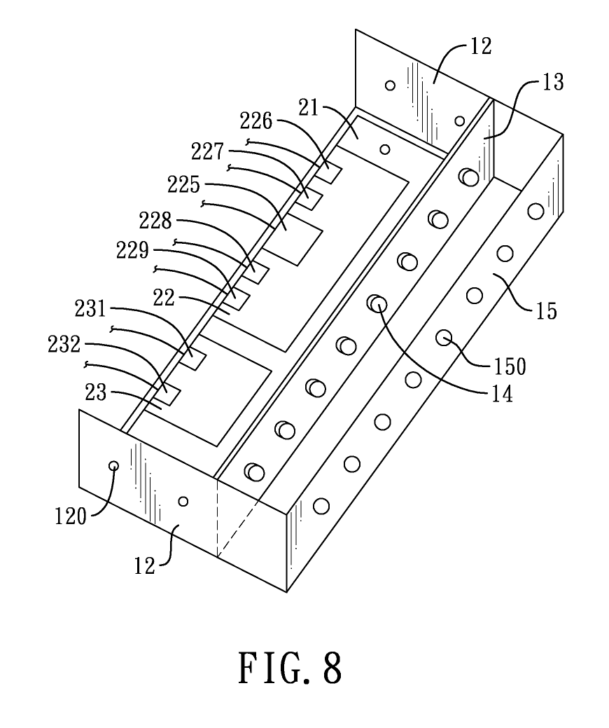

With reference to FIG. 6 and FIG. 7, a second embodiment in accordance with the present invention is disclosed. The switches 14 of the operation panel 13 comprise a first hard disk switch 141, a second hard disk switch 142, a third hard disk switch 146, a fourth hard disk switch 147, a fifth hard disk switch 148 and a sixth hard disk switch 149. The hard disk selector 22 has a first power output port 226, a second power output port 227, a third power output port 228 and a fourth power output port 229. The power output ports 226, 227, 228, 229 are respectively connected to a first hard disk, a second hard disk, a third hard disk and a fourth hard disk. With reference to FIG. 8, the box 10 can further comprise a shield 15 mounted in front of the operation panel 13 and separated from the operation panel 13. The shield 15 has multiple holes 150 respectively corresponding to the switches 14.

The first hard disk switch 141 is electrically connected among the power input port 225 and two power output ports, such as the first power output port 226 and the second power output port 227. The third hard disk switch 146 is connected between the first hard disk switch 141 and the first power output port 226. The fourth hard disk switch 147 is connected between the first hard disk switch 141 and the second power output port 227. The second hard disk switch 142 is electrically connected among the power input port 225 and the other power output ports, such as the third power output port 228 and the fourth power output port 229. The fifth hard disk switch 148 is connected between the second hard disk switch 142 and the third power output port 228. The sixth hard disk switch 149 is connected between the second hard disk switch 142 and the fourth power output port 229.

According to the second embodiment in accordance with the present invention, there are multiple switch combinations that users can make use of. When the first hard disk switch 141 and the third hard disk switch 146 are both ON and the second hard disk switch 142 and the fourth hard disk switch 147 are both OFF, the first hard disk can receive the operating voltage from the first power output port 226 and then the operating system installed in the first hard disk can be booted. When the first hard disk switch 141 and the fourth hard disk switch 147 are both ON and the second hard disk switch 142 and the third hard disk switch 146 are both OFF, the second hard disk can receive the operating voltage from the second power output port 227 and then the operating system installed in the second hard disk can be booted. Similarly, the operating system installed in the third hard disk is activated as long as the second hard disk switch 142 and the fifth hard disk switch 148 are both ON. The operating system installed in the fourth hard disk is activated as long as the second hard disk switch 142 and the sixth hard disk switch 149 are both ON. Only if the first network switch 143 is ON or the second network switch 144 and the third network switch 145 are both ON can the four hard disks communicate with the Internet.

According to the embodiments mentioned above, because the activations of hard disks and the communication with the Internet occur in certain combinations of the switches, the user has to pay more attention to regulate a certain combination of the switches. The incorrect operations, such as a hard disk that should not but communicates with the internet, will efficiently decrease.

With reference to FIG. 1, because the shield 15 covers the switches 14, the user has to push a stick 50, such as a pen, through the hole 150 to activate a corresponding switch 14. Hence, the incorrect combinations for the switches 14 efficiently decrease because the user operates the switches 14 through more acts. In addition, the structure of the shield 15 is not restricted by the disclosures of the embodiments in accordance with the present invention. For example, to reach the same purpose that prevents the switches from being carelessly touched, the switches can be sunk into the operation panel as the shield 15.

The device in accordance with the present invention is not only applied to the host of a personal computer, but also applied to laptops. Such a laptop may have a network port and multiple hard disks with different operating systems. The circuit diagrams in accordance with the present invention are available for the hard disks and a network port of the laptop.

Even though numerous characteristics and advantages of the present invention have been set forth in the foregoing description, together with details of the structure and features of the invention, the disclosure is illustrative only. Changes may be made in the details, especially in matters of shape, size and arrangement of parts within the principles of the invention to the full extent indicated by the broad general meaning of the terms in which the appended claims are expressed.

What is claimed is:

1. A device for a multi-boot system with network switches comprising:
a box having an operation panel mounted with multiple switches;
a selection module comprising:
a substrate mounted in the box;
a hard disk selector mounted on the substrate and electrically connected to the switches and having:
a power input port adapted to connect to a power supply;
multiple power output ports connected to the power input port via part of the switches; and
multiple plugs respectively connected to the power output ports and respectively adapted to connect to hard disks; and
a network selector mounted on the substrate and electrically connected to the other switches and having
a network input port; and
a network output port connected to the network input port via the other switches and adapted to connect to a network connector of a host via a network cable; and
a bridge connecting card mounted outside of the box and having
a network connector electrically connected to the network input port of the network selector and adapted to communicate with Internet; and
a hole allowing the network cable to pass through the bridge connecting card to connect to the network output port.

2. The device as claimed in claim 1 further comprising a shield, wherein the shield is mounted in front of the operation panel to prevent the switches from being touched.

3. The device as claimed in claim 2, wherein
the hard disk selector comprises the power input port, a first power output port and a second power output port;
the switches of the operation panel comprise:
a first hard disk switch electrically connected between the power input port and the first power output port;
a second hard disk switch electrically connected between the power input port and the second power output port;
a first network switch electrically connected between the network input port and the network output port of the network selector;
a second network switch; and
a third network switch connected to the second network switch in series, wherein the second network switch and the third network switch are electrically connected between the network input port and the network output port of the network selector.

4. The device as claimed in claim 3, wherein the second hard disk switch and the third network switch form a synchronous switch pair.

5. The device as claimed in claim 2, wherein
the hard disk selector comprises the power input port, a first power output port, a second power output port, a third power output port and a fourth power output port;
the switches of the operation panel comprise:
a first hard disk switch electrically connected among the power input port, the first power output port and the second power output port;
a second hard disk switch electrically connected among the power input port, the third power output port and the fourth power output port;
a third hard disk switch electrically connected between the first hard disk switch and the first power output port;
a fourth hard disk switch electrically connected between the first hard disk switch and the second power output port;
a fifth hard disk switch electrically connected between the second hard disk switch and the third power output port;
a sixth hard disk switch electrically connected between the second hard disk switch and the fourth power output port;
a first network switch electrically connected between the network input port and the network output port of the network selector;
a second network switch; and
a third network switch connected to the second network switch in series, wherein the second network switch and the third network switch are electrically connected between the network input port and the network output port of the network selector.

6. The device as claimed in claim 2, wherein
the shield is mounted in front of the operation panel and is separated from the operation panel; and
the shield has multiple holes respectively corresponding to the switches of the operation panel.
